(19) United States
(12) Patent Application Publication
(10) Pub. No.: US 2010/0145484 A1
(43) Pub. Date: Jun. 10, 2010

(54) SYSTEM AND METHOD FOR MONITORING COMPUTERIZED NUMERICAL CONTROL DEVICES

(75) Inventors: CHIA-JUNG YANG, Tu-Cheng (TW); FEI-HSU CHEN, Tu-Cheng (TW)

Correspondence Address: PCE INDUSTRY, INC.;ATT. Steven Reiss, 288 SOUTH MAYO AVENUE, CITY OF INDUSTRY, CA, 91789, US

(73) Assignee: FOXNUM TECHNOLOGY CO., LTD., Tucheng City (TW)

(21) Appl. No.: 12/346,780

(22) Filed: Dec. 30, 2008

(30) Foreign Application Priority Data
Dec. 4, 2008 (CN) 200810305954.8

(51) Int. Cl. G05B 19/00

(52) U.S. Cl. 700/83

(57) ABSTRACT

A monitoring system includes at least one CNC device and a monitoring device. Each of the CNC devices includes a movement control unit, a first document module stores the IP address and the related parameters of the CNC device, a human machine interface (HMI) receives a first input instruction, and a controller reads the related parameters from the first document module according to the first input instruction and outputs a movement control instruction to the movement control unit, and stores the movement parameters in the first document module. The monitoring device includes a second document module stores the IP address of the CNC device and the movement parameters of the CNC device, a display device, a processor reads the movement parameters from the second document module according to a second input instruction, and displays the movement parameters via the display device.

### BACKGROUND

1. Technical Field

The present disclosure relates to monitoring systems and monitoring methods and, particularly, to a monitoring system and method for monitoring computerized numerical control (CNC) devices.

2. Description of Related Art

In a CNC machine, a plurality of programs corresponding to different processes is stored in a controller. A plurality of soft keys is arranged on an operating panel of the CNC machine, each corresponding to one of the plurality of programs. When an article is to be processed, a corresponding program is selected via a corresponding soft key. Conventionally, a number of CNC machines are used in a workshop to improve output. However, monitoring states of all these CNC machines is complex and difficult.

### BRIEF DESCRIPTION OF THE DRAWINGS

FIG. 1 is a topology schematic diagram of an embodiment of a monitoring system, the monitoring system including a computer and a plurality of computerized numerical control (CNC) devices.

FIG. 2 is a block diagram of one CNC device and the computer of the monitoring system of FIG. 1.

FIG. 3A is a partial flowchart of an embodiment of a monitoring method for monitoring a CNC device of FIG. 2.

FIG. 3B is another partial flowchart of the monitoring method of FIG. 3A.

### DETAILED DESCRIPTION

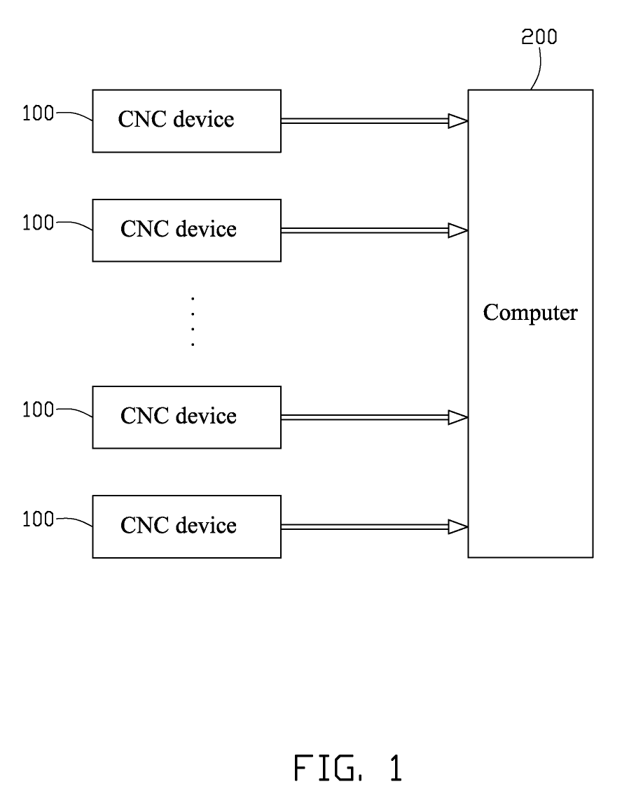

Referring to FIG. 1, an exemplary embodiment of a monitoring system includes a plurality of computerized numerical control (CNC) devices 100 and a monitoring device, such as a computer 200. The computer 200 may access the Internet via a network wire.

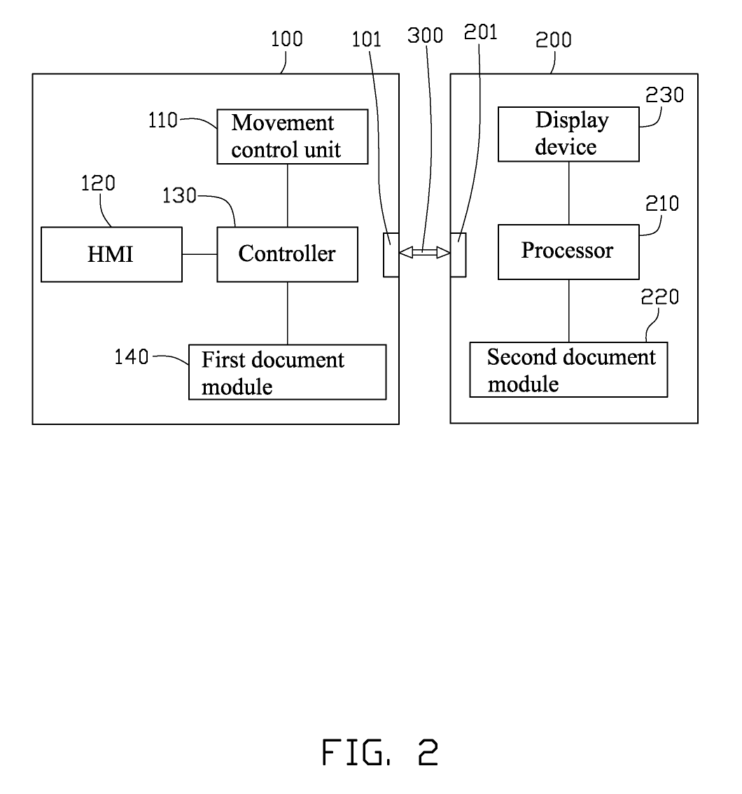

Referring to FIG. 2, each CNC device 100 includes a movement control unit 110, a human machine interface (HMI) 120, a controller 130, and a first document module 140. The movement control unit 110 is mounted inside of the CNC device 100, configured for controlling movement of the CNC device 100. The first document module 140 is configured for storing an IP address and related parameters of the CNC device 100. The HMI 120 is configured for receiving a first input instruction from a user and sending the first input instruction to the controller 130. The controller 130 is configured for reading the related parameters from the first document module 140 according to the first input instruction, and outputting a movement control instruction to the movement control unit 110 for controlling movement of the CNC device 100. The movement control unit 110 returns movement parameters to the controller 130, and the controller 130 stores the movement parameters in the first document module 140.

The computer 200 includes a processor 210, a second document module 220, and a display device 230. The second document module 220 is configured for storing the IP address of the CNC device 100 and the movement parameters of the CNC device 100 from the controller 130. The processor 210 is configured for receiving a second input instruction from the user and reading the movement parameters from the second document module 220 according to the second input instruction, and displaying the movement parameters via the display device 230. The state of the CNC device 100 can be monitored by the computer 200.

A network interface 201 of the computer 200 is electrically connected to a network interface 101 of the CNC device 100 via a network wire 300. If the computer 200 needs to connect to the plurality of CNC devices 100, a network router or a network hub can be added. The CNC device 100 communicates with the computer 200 through transmission control protocol/internet protocol (TCP/IP). In one embodiment, the first document module 140 and the second document module 220 are dynamic link library (DLL) documents.

In use, the IP address of the CNC device 100 can be preset in the first document module 140 of the CNC device 100. The CNC device 100 is booted up, the HMI 120 receives the first input instruction and sends the first input instruction to the controller 130. The controller 130 reads the related parameters from the first document module 140 according to the first input instruction to output the movement control instruction to the movement control unit 110 for controlling movement of the CNC device 100, and stores the returned movement parameters from the movement control unit 110 in the first document module 140. The processor 210 receives the second input instruction and reads an IP address from the second document module 220 according to the second input instruction, and sends the IP address to the CNC device 100. The CNC device 100 compares the IP address with its own IP address. If the IP addresses are identical, the CNC device 100 electrically connects with the computer 200. The CNC device 100 sends the movement parameters of the CNC device 100 stored in the first document module 140 to the computer 200. The processor 210 receives the movement parameters from the CNC device 100 and stores the movement parameters in the second document module 220, and displays the movement parameters to a user via the display device 230. The user can obtain states of the CNC device 100 by noting the movement parameters displayed in the display device 230.

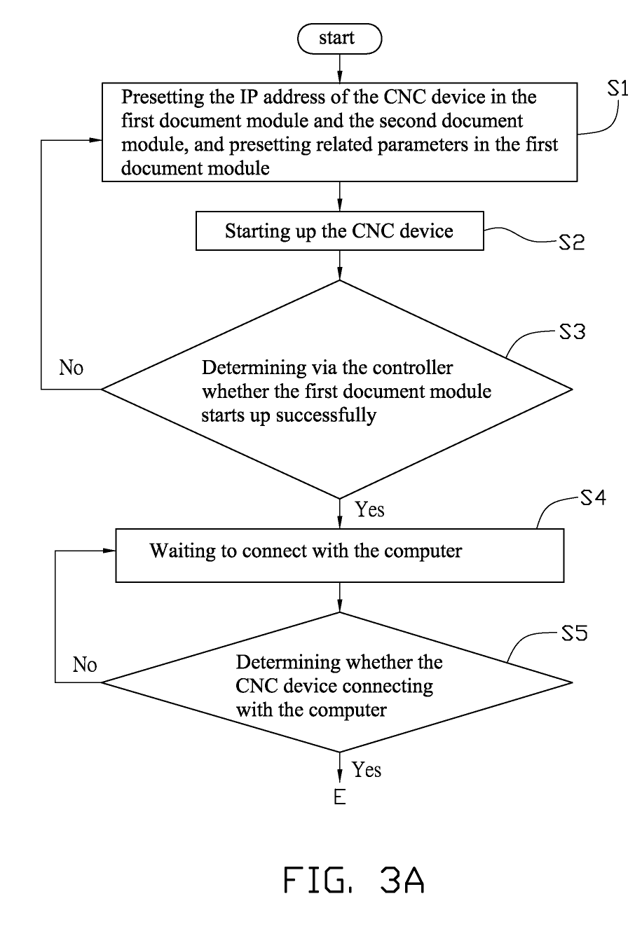

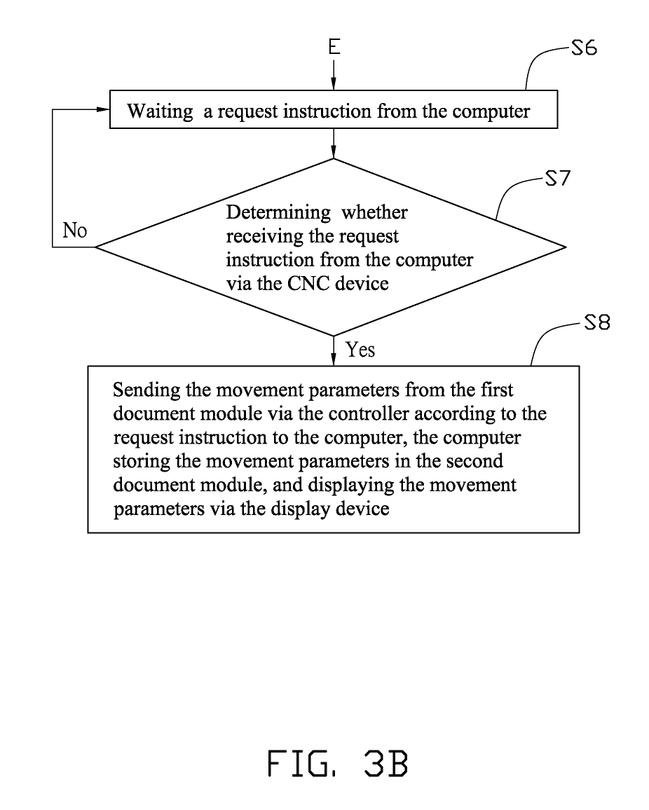

Referring to FIGS. 3A and 3B, an exemplary embodiment of a monitoring method for monitoring computerized numerical control (CNC) devices includes the following steps.

Step S1: presetting an IP address of each of the CNC devices 100 in the first document module 140 and the second document module 220, and presetting related parameters of the CNC device 100 in the first document module 140.

Step S2: starting up the CNC device 100.

Step S3: determining via the controller 130 whether the first document module 140 starts up successfully. If no, go back to step S1. If yes, go to step S4.

Step S4: reading the related parameter via the controller 130 from the first document module 140 according to a first input instruction from a user and outputting a movement control instruction to the movement control unit 110, the movement control unit 110 controlling movement of the CNC device 100 according to the movement control instruction and returning movement parameters to the controller 130, the controller 130 storing the returned movement parameters in the first document module 140. The CNC device 100 waits to connect with the computer 200.

Step S5: reading an IP address via the processor 210 from the second document module 220 according to a second input instruction from the user and sending the IP address to the CNC device 100, and determining whether the CNC device 100 connects with the computer 200.

Step S6: comparing the read IP address with the IP address of the CNC device 100, if the IP addresses are identical, the CNC device 100 connects with the computer 200 and waits for a request instruction from the computer 200, otherwise go back to step S4.

Step S7: determining whether receiving the request instruction from the computer 200 via the CNC device 100. If no, go back to step S6. If yes, go to step S8.

Step S8: sending the movement parameters from the first document module 140 via the controller 130 according to the request instruction to the computer 200, the computer 200 stores the movement parameters in the second document module 220, and displays the movement parameters via the display device 230.

The computer 200 connects with the CNC device 100 according to the IP address for controlling the CNC device 100 to send the movement parameters from the first document module 140 to the computer 200. The user may monitor the state of the CNC device 100 via the computer 200. The monitoring system can monitor a number of CNC devices conveniently.

The foregoing description of the exemplary embodiments of the disclosure has been presented only for the purposes of illustration and description and is not intended to be exhaustive or to limit the disclosure to the precise forms disclosed. Many modifications and variations are possible in light of the above teaching. The embodiments were chosen and described in order to explain the principles of the disclosure and their practical application so as to enable others skilled in the art to utilize the disclosure and various embodiments and with various modifications as are suited to the particular use contemplated. Alternately embodiments will become apparent to those skilled in the art to which the present disclosure pertains without departing from its spirit and scope. Accordingly, the scope of the present disclosure is defined by the appended claims rather than the foregoing description and the exemplary embodiments described therein.

What is claimed is:

1. A monitoring system comprising:
at least one CNC device, each of the at least one CNC device comprising:
a movement control unit;
a first document module configured for storing an IP address and related parameters of the CNC device;
a human machine interface (HMI) configured for receiving a first input instruction; and
a controller configured for receiving the first input instruction from the HMI, and reading the related parameters from the first document module according to the first input instruction and outputting a movement control instruction to the movement control unit, for controlling movement of the CNC device, and storing returned movement parameters from the movement control unit in the first document module; and
a monitoring device comprising:
a second document module configured for storing the IP address of the CNC device and the movement parameters of the CNC device;
a display device configured for displaying the movement parameters of the CNC device;
a processor configured for receiving a second input instruction and reading the movement parameters of the CNC device from the second document module according to the second input instruction, and displaying the movement parameters via the display device.

2. The monitoring system of claim 1, wherein the movement control unit is mounted inside of the CNC device.

3. The monitoring system of claim 1, wherein each of the at least one CNC device communicates with the monitoring device via TCP/IP protocol.

4. The monitoring system of claim 1, wherein the monitoring device is a computer.

5. A monitoring method for monitoring at least one CNC device, the monitoring method comprising:
presetting an IP address of each of the at least one CNC device in a first document module and a second document module, and presetting related parameters of each of the at least one CNC device in the first document module;
starting up each of the at least one CNC device;
determining whether the first document module start up successfully, if no, go to the presetting step, if yes, go to the following step;
reading the related parameters of the first document module according to an input instruction and outputting a movement control instruction to a movement control unit for controlling movement of the each of the at least one CNC device, and storing returned movement parameters from the movement control unit in the first document module, the each of the at least one CNC device waiting to connect with the monitoring device;
providing a monitoring device to read an IP address from the second document module according to an second input instruction, and sending the IP address to the at least one CNC device for determining whether the at least one CNC device connecting with the monitoring device;
comparing the read IP address with the IP address of each of the at least one CNC device, if the IP addresses being identical, the at least one CNC device connecting with the monitoring device, and waiting a request instruction from the monitoring device, otherwise go to the step of the at least one CNC device waiting connect with the monitoring device;
determining whether receiving the request instruction from the monitoring device, if no, go to the step of the at least one CNC device waiting the request instruction from the monitoring device, if yes, go to the following step; and
sending the movement parameters from the first document module according to the request instruction to the monitoring device, the monitoring device storing the movement parameters in the second document module, and displaying the movement parameters.

6. The monitoring method of claim 5, wherein the at least one CNC device communicates with the monitoring device via TCP/IP protocol.

7. The monitoring method of claim 5, wherein the monitoring device is a computer.
